(19) United States
(12) Patent Application Publication
(10) Pub. No.: US 2009/0035558 A1
(43) Pub. Date: Feb. 5, 2009

(54) SINTERED CERAMIC PRODUCT HAVING A NITROGENOUS MATRIX WITH IMPROVED SURFACE PROPERTIES

(75) Inventors: Eric Jorge, Les Valayans (FR); Frederic Roulet, Salon De Provence (FR); Jacques Schoennahl, Valenciennes (FR)

Correspondence Address: YOUNG & THOMPSON, 209 Madison Street, Suite 500, ALEXANDRIA, VA, 22314, US

(73) Assignee: Saint-Gobain Centre De Recherches ET D'Etudes Europeen, Courbevoie (FR)

(21) Appl. No.: 12/091,869

(22) PCT Filed: Oct. 27, 2006
(86) PCT No.: PCT/FR2006/002422

§ 371 Date: Aug. 11, 2008

(30) Foreign Application Priority Data
Oct. 28, 2005 (FR) 0511073

(51) Int. Cl. B32B 15/04; C04B 35/64; B32B 5/14; B32B 9/00

(52) U.S. Cl. 428/332; 264/610; 428/702; 428/698; 428/696; 428/472; 428/689; 428/446

(57) ABSTRACT

The sintered ceramic product comprises a granular material bound by a nitrogenous mold. According to the invention, at least one anti-dust agent selected among calcium and boron exists in a surface layer of the product, the mass ratio of all the anti-dust agents in the surface layer being greater than that measured underneath this layer. This product advantageously has a reduced ratio of non-adherent particles to its surface.

The present invention relates to a sintered ceramic product comprising a granular material bound by a nitrogenous matrix and a method for its manufacture.

Because of the presence of a nitrogenous matrix this manufacture requires reactive sintering. Nitrogen, generally supplied by means of a nitrogen atmosphere then reacts during sintering and forms a nitrogenous matrix, for example made of SiAlON, which serves as a binder for a granular material, for example silicon carbide, SiAlON, or alumina. In the following description, these products are referred to as “nitrogenous matrix” materials.

Sintered products having a nitrogenous matrix should be distinguished from products manufactured by non-reactive sintering, for example by sintering a mixture of Si₃N₄ and BN powders. In the non-reactive sintering methods, the nitrogen supplied by means of the raw materials undergoes little or no reaction during sintering, lime (CaO) or magnesia (MgO) being commonly used to promote sintering. Non-reactive sintering leads to an aggregation of grains without creating a binding matrix. Non-reactive sintering is more costly than reactive sintering. Moreover, it results in products having greater shrinkage when sintered.

The sintered products having a nitrogenous matrix should also be distinguished from products containing no grains. The properties of the latter products are generally quite different, in particular in terms of their thermal conductivity and corrosion resistance.

Refractory products having a silicon nitride- or SiAlON-based nitrogenous matrix are described, for example, in U.S. Pat. No. 2,752,258, EP 0 153 000 or U.S. Pat. No. 4,533,646, which discloses a corundum-based product bound by means of nitride formed in situ by reaction of the firing atmosphere with components of the mixture, in particular with silicon and alumina powders. Such products are also known from U.S. Pat. No. 4,243,621, which discloses SiAlON products, or from U.S. Pat. No. 4,348,092. To improve the mechanical strength of a silicon nitride product having a nitrogenous matrix, U.S. Pat. No. 4,038,092 suggests impregnating the surface of such a sintered product with alumina and to fire it in a nitrogen atmosphere. This results in a SiAlON surface layer which enhances the sintered product's strength.

Sintered ceramic materials having a nitrogenous matrix, in particular those materials having a matrix of silicon nitride or SiAlON, however form structures that are more or less crystallized, having a rather oblong or needle-like shape, with a typical diameter of 0.1 to 2 μm and a length of up to about 1000 μm. These particulate structures form, on the surface of the manufactured parts, a dusty layer which may or may not be continuous and has little adhesiveness. This dusty layer leads to some problems, in particular, in terms of adherence to jointing cements. It may also sensitize the parts to rusting, and lead, under certain conditions, to accelerated corrosion phenomena. Finally, this dusty layer may be more or less regular and may vary from one part to another, and generate color changes, which are be undesirable for the user.

To solve these problems, the parts are sometimes brushed after firing. However, this operation is time consuming and costly.

Therefore, there is a need for a sintered ceramic product having a nitrogenous matrix with improved surface properties, which can be manufactured by methods that are less costly than those of the prior art.

It is an object of the present invention to satisfy this need. According to the present invention, this object is achieved by means of a sintered ceramic product comprising a granular material bound by a nitrogenous matrix, noteworthy in that at least one anti-dust agent selected among calcium and boron exists in a surface layer of the product, the mass ratio of all the anti-dust agents in said surface layer being greater than that measured underneath said layer.

By “underneath the surface layer” is meant a region in the product extending directly underneath the surface layer. Preferably, this region extends down to at most 5 cm, preferably at most 500 μm, below the surface layer. In other words, to determine whether the mass ratio of anti-dust agents underneath the surface layer is less than that in this layer, the average ratios of anti-dust agents within the surface layer and within a layer having a thickness of at most 5 cm, and preferably at most 500 μm extending directly underneath the surface layer, are compared.

In one embodiment of the present invention, the anti-dust agent ratio in the surface layer is greater than that measured at any given point in the product beneath this surface layer, that is, the region “underneath the surface layer” comprises the whole product, except for the surface layer.

The boundary between the “surface layer” of a product and the region “underneath a surface layer” is determined by the depth from which, going down into the product from the surface towards the center of the product, the ratio of the anti-dust agent(s) remains substantially constant as a function of depth, which ratio must be maintained constant over at least 500 μm beyond the boundary. According to the present invention, the ratio of anti-dust agent(s) then reaches a constant value smaller than that measured, on average, within the surface layer.

The so-called “surface layer” of a product is the peripheral portion of the product, which extends from its surface down to this boundary. In the case where the anti-dust agents are deposited on the green part, the surface layer corresponds to a region extending from the product surface down to the end of the area where the diffusion of the deposited anti-dust agents is possible.

While there is no presently known theoretical explanation for this phenomenon, the present inventors have unexpectedly found that the presence of calcium and/or boron at the surface of a sintered nitrogenous product, resulting, for example, from a deposition on the green part, corresponds to a considerable decrease in the ratio of particles not adhering to this product. Therefore, it is henceforth no longer required to brush the sintered product.

Preferably, the surface layer extends over the whole surface of the product, but may also extend over only a portion thereof.

The sintered product according to the present invention also preferably has one or more of the following optional features:

The granular material and the matrix are made of refractory materials.

The surface layer has a mass ratio of anti-dust agents (boron+calcium) of 0.25% or more.

The surface layer has a calcium or boron ratio greater than the calcium or boron ratio, respectively, of the material underneath this surface layer.

The whole surface of the product is coated with a surface layer having a calcium ratio and/or boron ratio greater than the calcium ratio and/or boron ratio, respectively, underneath said layer. Preferably, the region of the product underneath the surface layer is comprised of a single material.

The calcium and/or boron exists in the form of at least one calcium compound and/or at least one boron compound, respectively, these compounds preferably being non-oxide compounds, that is oxygen-free compounds.

The calcium compound is preferably selected from the group consisting of oxides, carbides, nitrides, fluorides, metal alloys, calcium-containing organometallic compounds and, still more preferably, among CaB₆, CaSiO₃ and CaCO₃, and the boron compound is preferably selected from the group consisting of oxides, carbides, nitrides, fluorides, metal alloys, boron-containing organometallic compounds, in particular B₄C and CaB₆, BN, TiB₂ or H₃BO₃, preferably from the group consisting of B₄C and CaB₆, and still more preferably, the boron compound is CaB₆.

Said surface layer has a thickness of less than 1000 μm, preferably less than 500 μm.

In said surface layer of the product, the boron ratio is greater than 0.05% and/or the calcium ratio is greater than 0.2% and, underneath said layer, the boron ratio is less than 0.05% and/or the calcium ratio is less than 0.2%, respectively, in percentages by weight.

The granular material comprises silicon nitride and/or SiAlON and/or silicon carbide and/or alumina grains.

The anti-dust agent mass ratio within the surface layer exceeds, on average, by at least 10%, preferably by at least 20%, that measured underneath the surface layer, based on the ratio measured within the surface layer.

When the anti-dust agents are not taken into account, the product composition within the surface layer is substantially the same as that of the region underneath the surface layer. This characteristic is obtained, in particular, when the anti-dust agent is applied to the green part, possibly with other products such as a diluent, that are removed during sintering.

The present invention also relates to a green part adapted to form a nitrogenous matrix by reactive sintering, wherein the green part comprises at least one anti-dust agent selected from calcium and boron, the mass ratio of all said anti-dust agents in the surface layer being greater than that measured underneath said layer. Preferably, the green part is coated with a composition comprising said anti-dust agent.

Preferably, the green part according to the present invention has such characteristics that it can be transformed by sintering into a sintered nitrogenous product according to the present invention. In particular, it preferably has one or more of the following optional features:

The green part comprises grains of silicon nitride and/or SiAlON and/or silicon carbide and/or alumina, and preferably silicon carbide and/or alumina.

The green part comprises a nitride precursor. Sintering the green part then leads to a nitride matrix, preferably of Si₃N₄.

The surface layer has a calcium ratio or boron ratio greater than the calcium or boron ratio, respectively, of the material underneath said surface layer.

By “granular material” is meant a collection of refractory grains of which at least 90% in weight have a size comprised between 50 μm and 5 mm.

By SiAlON is meant any compound formed from a solid solution comprising a non-zero ratio of nitrogen (N), aluminum (Al), oxygen (O) and silicon (Si). There are different forms of SiAlON, such as β′SiAlON, the formula of which is Si_{6-z}Al_{z}O_{z}N_{8-z} where subscript z is strictly greater than zero, or O′SiAlON, the formula of which is Si₂₋ₓAlₓOₓ₊₁N₂₋ₓ where subscript x is greater than zero. However, the present invention is not restricted to any particular SiAlON.

By “matrix” is meant a phase, whether crystallized or not, ensuring a continuous structure between the grains and obtained during the thermal treatment (also known as sintering) from precursors introduced within the mixture, preferably in the form of powders having a median diameter of less than 200 microns.

By “calcium and/or boron ratio” is meant the weight percentage of calcium and/or boron, respectively, in whatever form, that is, in the form of elemental calcium/boron, or of a calcium/boron compound.

The present invention also relates to a method for manufacturing a sintered ceramic product having a nitrogenous matrix, comprising depositing boron and/or calcium on at least one portion of the surface of a green part, and then reactive sintering so as to manufacture a product according to the present invention.

The deposition of boron and/or calcium may be done in the form of an incorporation within the surface region of the green part, and/or of a coating applied to the green part.

Advantageously, the incorporation of boron and/or calcium and/or the application of a coating comprising boron and/or calcium to the surface of the green part, and therefore, before sintering, is entirely compatible with the firing process, in particular, with the debinding and diffusion of nitrogen down to the center of the parts to be sintered.

The conditions allowing a reactive sintering to be performed depend on the raw materials involved and are well known to one skilled in the art.

Preferably, the method according to the present invention comprises the steps of:

a) preparing a green part;

b) depositing a coating composition comprising boron and/or calcium on at least one portion of the surface of the prepared green part;

c) before or after step b), drying the green part;

d) firing the coated and dried green part in a reducing nitrogen atmosphere, or possibly, if the green part comprises nitrogen, in any non-oxidizing atmosphere, at a temperature ranging between 1300 and 1600° C., so as to obtain a sintered product having a nitrogenous matrix,

wherein the composition of the coating is selected so that the sintered product is according to the present invention.

Preferably, in step b), at least 0.1 g of dry materials per square meter of coated surface is deposited and/or more than 70 g of dry materials are deposited per square meter of coated surface.

Still more preferably, the following amounts of boron and/or calcium are deposited on the green part:

in the absence of boron, at least 1.6 g, preferably, at least 3.2 g, of calcium (Ca) per square meter of coated surface and per percent of nitrogen in the composition of the final sintered product;

in the absence of calcium in the coating composition, at least 1.2 g, preferably at least 2.4 g of boron (B) per square meter of coated surface and per percent of nitrogen in the composition of the final sintered product;

in the presence of boron and calcium in the coating composition, at least 0.4 g, preferably at least 0.8 g, of calcium (Ca) and/or at least 0.6 g, preferably at least 1.2 g of boron (B) per square meter of coated surface and per percent of nitrogen in the composition of the final sintered product.

Unless otherwise specified, all percentages are by weight.

The method according to the present invention described above comprises a first step of preparing a green part (step a)). Many methods are known by those skilled in the art for that purpose. In particular, powders of the raw materials (metal powders, oxides) may be mixed with one or more well known additives, and kneaded to form a starting batch.

In particular, the additives may comprise pressing additives. These additives comprise plasticizers, such as modified starches, or polyethylene glycols and lubricants, such as soluble oils or stearate derivatives.

The additives also conventionally comprise one or more binders serving to form, with the raw materials, a body which is sufficiently rigid to preserve its shape until the end of step c). The selection of the binder depends on the desired shape.

Any known binder or mixture of binders may be employed. The binders are preferably “temporary”, that is they are totally or partially eliminated during the steps of drying and firing the part. Still more preferably, at least one of the temporary binders is a solution of derivatives of modified starch, an aqueous solution of dextrin or derivatives of lignone, a solution of a synthetic agent such as polyvinyl alcohol, a phenol resin or another epoxy resin, a furfuryl alcohol, or a mixture thereof. Still more preferably, in at least one of the charges, the amount of temporary binder ranges from 0.5 to 7% by weight relative to the weight of raw materials in the charge.

Water is also conventionally added to the starting charge.

The amounts of these additives and added water are those conventionally employed when manufacturing nitrogenous sintered products of the prior art.

The mixing of the raw materials and additives is continued until a substantially homogenous starting charge is obtained.

Thereafter, the starting charge is placed in a mold and then pressed by exerting a force on the upper layer of the charge so as to transform it into a green part adapted to be sintered. A specific pressure of 300 to 600 kg/cm² is appropriate. Pressing is preferably carried out uniaxially or isostatically, for example by means of a hydraulic press. It may advantageously be complemented by a tamping, manual or pneumatic or vibrational ramming operation.

A green part is thus obtained, which may be demolded.

Alternatively, a slip may be prepared by suspending a raw material powder in a liquid, for example in water, with or without additives such as binders, preferably temporary binders, dispersants, deflocculants, polymers, and the like. The slip is cast into a porous mold, and the liquid is then removed from the mold until setting. The obtained green part is then demolded.

Independently from the preparation of the green part, a coating composition is prepared, which contains boron and/or calcium, preferably boron and/or calcium compounds (step b)).

In order to manufacture the coating composition, a powder containing boron and/or calcium may be mixed with an aqueous or non-aqueous diluent such as water until a homogeneous composition is obtained.

The powder used is preferably selected so that at least 90% by weight of the particles have a size of less than 300 μm, more preferably less than 200 μm, and even more preferably less than 100 μm. The product according to the present invention then has an improved ability to adhere to jointing cements.

Preferably, the application of the coating composition is carried out before the binders harden. It may be carried out by projection (e.g., by spray coating) or by direct application onto the surface (e.g., by means of a brush or roll), or even by dipping if the diluent of the coating composition does not lead to a problem of disintegration of the green part. The content of dry materials in the coating composition is determined as a function of the selected application mode.

Preferably, from 0.1 to 70 g of dry materials per square meter of the surface are deposited on the surface of the green part, since a deposition by weight of more than 70 g/m² would lead to application problems. The deposition thickness is preferably at most 500 μm after firing. Advantageously, the appearance of the final product is thus preserved. The amount of dry materials to be deposited per square meter of the surface and the possible presence of additives will allow one skilled in the art to select the best suited application mode.

In step c), the green part, which is at least partially coated with the coating composition, is dried, for example by being stored in an oven having controlled temperature and humidity, according to conventional processes. Drying may be carried out at a moderately high temperature. It is preferably carried out at a temperature ranging between 110 and 200° C. Conventionally, its duration ranges between 10 hours and 1 week according to the shape of the part, until the residual humidity of the part is 0.5% or less.

Thereafter, the part is conventionally sintered, that is, densified by a thermal treatment (step d)) under well known conditions, so as to allow reactive sintering to take place. The green part may be placed in a non-oxidizing atmosphere if nitrogen is supplied through the raw materials, for example through a SiAlON powder, or in a reducing nitrogen atmosphere. The supply of nitrogen through the raw materials is particularly advantageous for parts having large dimensions and/or little porosity, in which nitrogen gas may hardly penetrate.

The pressure is preferably the atmospheric pressure but a higher pressure could be appropriate. The maximum temperature stage is between 1300 and 1600° C. so that the nitride phase(s) of the binding matrix can be formed.

During the reactive sintering, nitrogen reacts with the raw materials and the charge in order to form a nitrogenous matrix adapted to bind the grains within said charge. This results in a sintered monolithic product according to the present invention which, surprisingly, has a reduced ratio of non-adherent particles.

This product has a darker and more homogeneous external color than that of a non-treated product. The color may vary to greenish-gray.

The invention will be further illustrated in the following non-limiting examples.
In order to characterize the ratio of non-adherent particles (test #1), a 48 mm wide adhesive tape, for example Scotch® Box Sealing Tape 355 (a polyester and a resin of synthetic rubber) is adhered to the surface of the tested product and then removed. This operation is reiterated until all non-adherent particles have been removed from this surface. By observing the adherent surface of the tape with a scanning electron microscope, it is verified that only non-adherent particles, rather than the grains (having a diameter of more than 200 microns), have been detached. Thereafter, the stripped-off mass is weighed and divided by the surface of adhesive tape adhering to the surface of the tested product to obtain the Tw index, in g/m². This measurement is combined with an observation of the tested product's surface using a scanning electron microscope in order to verify that all non-adherent particles were properly stripped off.
The measurement of crystallized phases on the surface of the tested product is carried out by X-ray diffraction.
The nitrogen (N) ratios in the products were measured by means of LECO analyzers (LECO TC 436 DR; LECO CS 300). The given values are percentages by weight.
The calcium and/or boron ratio was measured locally by means of an EDS (energy dispersion spectroscopy) probe or, for calcium, of a WDS (Wave Dispersion Spectroscopy) microprobe, and, to obtain the average in the deposit, through chemical analysis.
The oxidation tests were carried out according to the ASTM C863 Standard. The samples (having a typical size of 25×25×120 mm) undergo a test of at least 100 hours at 900° C. in an atmosphere saturated with steam. The weight and volume uptakes are indicative of the oxidation level.
A first corrosion test was carried out by observing the degree of corrosion of an assembly of two test pieces joined together by a cement joint, in the junction area between the joint and the test pieces, after this assembly has been rotated at 2 cm/s in an argon atmosphere, within a blast-furnace and cast slag at 1500° C. for 4 hours.
According to a second corrosion test, the assembly of two test pieces joined together by a cement joint was rotated at 2 cm/s in argon, within a cryolitic batch in an oxidizing medium at 1030° C., with dry air blowing at 1 l/min for 8 hours. The cryolitic bath typically had the following weight composition: 80% cryolite, 13% aluminum fluoride, 5% alumina, the rest being impurities.

Products such as SiC/Si₃N₄ (product A), SiC/SiAlON (product B) and Corundum/SiAlON (product C) were tested. Table 1 provides the compositions of the starting charges in percentages by weight.

TABLE 1

| | | |
|---|---|---|
| A | B | C |

Raw materials (percentages by weight relative to the total
raw materials)

| | | | |
|---|---|---|---|
| Mixture of grains and SiC powders | 86 | 80 | |
| Mixture of grains and black corundum | | | 80 |
| powders | | | |
| Metal silicon powder (D50 < 200 | 14 | 8 | 7 |
| microns) | | | |
| Metal aluminum powder (<200 microns) | | 3 | 5 |
| Fine calcined alumina powder (D50 < | | 9 | 8 |
| 200 microns) | | | |
| Total raw materials | 100 | 100 | 100 |

Added materials¹

| | | | |
|---|---|---|---|
| Added lignone | 2.5 | | |
| Added starch or derivative | 1 | 1 | 1 |
| Added soluble oil or lubricant | <1 | | |
| Added water | 2.5-3.5 | 4-6.5 | 4-6.5 |

¹The added materials are given in percentages by weight relative to the total weight of raw materials (mixtures of grains and mineral and metal powders).

90% by weight of particles in the used mixture of grains and SiC powders have a size ranging between 0.05 and 5 mm.

90% by weight of the particle in the used mixture of black corundum grains and powders have a size ranging between 0.05 and 5 mm.

Products A, B and C are manufactured as follows.

First, the raw materials, additives and water are thoroughly kneaded by means of an Eirich kneader for 5 to 20 minutes, in the proportions given in Table 1, so as to make a starting charge.

The starting charge is placed in a mold having dimensions of 230*114*130 mm, and then pressed with a typical specific pressure of 500 kg/cm² in order to obtain a green part having dimensions of 230*114*65 mm.

After demolding, the green part is gun-sprayed with a coating composition of CaCO₃, or CaSiO₃, or B₄C, or CaB₆.

The coating composition is prepared by mixing 15 to 30 g of a powder of CaCO₃ (of the OMYA type; average diameter (D50) of 4 μm), or B₄C (a powder with a D50 of 10 microns available from ESK), or CaSiO₃ (97% by weight of the particles passing through a screen having a mesh opening of 50 μm (270 mesh); a powder available from Nordkalk Partek), or CaB₆ (D50<45 microns, available from ESK), with 100 to 250 g of distilled water, and then manually agitating until a homogenous solution is obtained.

The projection apparatus is typically a paint gun such as the Aerografo Spray Gun 9011 HVLP available from Asturo. The typical spraying distance is 80 cm from the green part. The deposited amount per unit surface is checked by weighing calibrated targets arranged around the part to be coated.

The coated green part is then left in open air until the residual humidity reaches less than 0.5%.

Finally, it is fired in a non-oxidizing nitrogen atmosphere at a temperature ranging between 1300 and 1600° C.

Table 2 below gives the compositions of the obtained sintered products, in percentages by weight, without taking into account anti-dust agents.

TABLE 2

| | A | B | C |
|---|---|---|---|
| SiC | 78 | 76 | |
| Al₂O₃ in the form of Corundum | | 4 | 84 |
| Nitride binding phase in the form of | 20 | | |
| Si₃N₄ | | | |
| Nitride binding phase in the form of | | 18 | 15 |
| SiAlON | | | |
| Impurities and non-crystallized | 2 | 2 | 1 |
| phases | | | |

Table 3 below illustrates the efficiency in terms of the reduction in the non-adherent particle ratio, Tw, as a function of concentration, of various calcium and/or boron-based addition forms, for the three ranges of products A, B and C.

The amounts of CaCO₃, CaSiO₃, B₄C and CaB₆, expressed in g/m², and the amounts of calcium and boron expressed in g/m² and per percent of nitrogen in the product, are the amounts applied to the green part and not the amounts measured on the sintered part.

TABLE 3

| | A | | | B | | | C | | |
|---|---|---|---|---|---|---|---|---|---|
| Nitrogen ratio, | 6.5% | | | 6% | | | 5% | | |
| weight percent | | | | | | | | | |
| Index Tw according | 6.5 | | | 12 | | | 12 | | |
| to test #1 on the | | | | | | | | | |
| non-treated reference | | | | | | | | | |
| product (g/m²) | | | | | | | | | |
| % in number of removed | 50% | 75% | 90% | 50% | 75% | 90% | 50% | 75% | 90% |
| non-adherent | | | | | | | | | |
| particles (Tw for | | | | | | | | | |
| the treated product/ | | | | | | | | | |
| Tw for the non- | | | | | | | | | |
| treated product) | | | | | | | | | |
| CaCO₃ in g/m² | 4 | 8 | 10 | 3 | 6 | 8 | 2 | 5 | 7.5 |
| Ca in g/m² per % | 0.25 | 0.49 | 0.62 | 0.20 | 0.40 | 0.53 | 0.16 | 0.40 | 0.80 |
| nitrogen | | | | | | | | | |
| CaSiO₃ in g/m² | 3 | 7 | 10 | 3 | 7 | 10 | 3 | 7 | 10 |
| Ca in g/m² per % | 0.16 | 0.37 | 0.52 | 0.17 | 0.40 | 0.57 | 0.20 | 0.48 | 0.68 |
| nitrogen | | | | | | | | | |
| B₄ in g/m² | 1 | 1.8 | 3 | 1 | 2.1 | 3 | 1 | 2.3 | 3 |
| B in g/m² per % nitrogen | 0.12 | 0.22 | 0.36 | 0.13 | 0.28 | 0.40 | 0.16 | 0.38 | 0.47 |
| CaB₆ in g/m² | 0.7 | 1.5 | 2.5 | 0.7 | 1.6 | 2.5 | 0.5 | 1.5 | 2.5 |
| Ca in g/m² per % | 0.04 | 0.09 | 0.15 | 0.04 | 0.10 | 0.16 | 0.04 | 0.11 | 0.19 |
| nitrogen | 0.07 | 0.14 | 0.24 | 0.07 | 0.17 | 0.26 | 0.08 | 0.19 | 0.31 |
| B in g/m² per % | 0.11 | 0.23 | 0.38 | 0.12 | 0.27 | 0.42 | 0.10 | 0.30 | 0.50 |
| nitrogen | | | | | | | | | |
| Ca + B in g/m² per % | | | | | | | | | |
| nitrogen | | | | | | | | | |

It may be seen that the percentage of removed non-adherent particles increases with the amount of calcium or boron applied to the surface of the green part. For the same percentage of removed non-adherent particles, this amount also varies depending on the type of treated product.

For a given product, in order to obtain a determined percentage of removed non-adherent particles, it may be seen that it is required to supply more calcium, in g/m², than boron. Preferably, the coating composition is therefore a composition that comprises at least boron.

Moreover, it may be seen that the combined addition of calcium and boron has a noticeable synergetic effect, thus advantageously allowing the amount of total added elements to be reduced.

Two products made of materials having the same kind of binding phase, for example both products B and C comprising SiAlON, may have different nitrogen ratios. Therefore, it is useful to compare the calcium or boron ratios per square meter divided by the mass ratio of nitrogen in the product.

It may be seen that, in the presence of boron, at least 0.04 g of elemental calcium per m² of the surface and per percent of nitrogen in the product composition (at least 0.16 g/m²·% N without jointly added boron) must be deposited in order to remove at least half of the non-adherent particles. In the presence of calcium, at least 0.06 g of elemental boron per m² of the surface and per percent of nitrogen in the product composition (at least 0.12 g/m²·% N without jointly added calcium) is required to remove at least half of the non-adherent particles.

Preferably, to ensure nearly total removal of non-adherent particles, these ratios are about 10 to 20 times greater. Therefore, in the presence of boron, it is required to deposit at least 0.4 g, preferably at least 0.8 g of elemental calcium per m² of the surface and per percent of nitrogen (at least 1.6 g/m²·% N, preferably 3.2 g/m²·% N without jointly added boron) and at least 0.6 g, preferably 1.2 g of elemental boron per m² of the surface and per percent of nitrogen in the product composition (at least 1.2 g/m²·% N, preferably 2.4 g/m²·% N without jointly added calcium).

Microscope (SEM) observations of products A and C treated according to the present invention are consistent with the results of test #1 (Table 3). Surprisingly, X ray diffraction analyses show the presence of anorthite on the surface of material C treated with at least 0.5 g/m² of calcium.

Samples taken from beneath the surface layers of products A and C typically have a boron concentration of <0.05% and calcium concentration of <0.2% as measured by chemical analysis and expressed in percentages by weight. Conversely, the surface layer of the products according to the present invention, when coated with a composition comprising a calcium compound and/or boron compound have a boron concentration of >0.05% and/or a calcium concentration of >0.2% in percentages by weight. A microprobe analysis also allows the weight concentration, for example of calcium, to be quantified in this surface layer.

The tests jointly performed on products A, B, and C coated according to the present invention, with refractory cements conventionally used for well known non-coated parts A, B, and C, do not show any particular adherence or thermal mechanical strength problems, in particular in the above-mentioned deposition ranges (g/m² or g/m²·% N).

The oxidizing tests show that the deposition remains coherent as no peeling phenomenon can be noticed.

The first corrosion test was carried out on two test pieces jointed with material C. This test does not show any preferential corrosion at the joint between both treated test pieces when less than 70 g of CaCO₃ powder is applied per square meter, that is, about 5.6 g of calcium per square meter and per percent of nitrogen in the product, when the deposition is carried out with CaCO₃.

The second corrosion test was carried out on two test pieces jointed with material A. It does not show any preferential corrosion at the joint between the treated test pieces when less than 60 g of B₄C powder is applied per square meter, that is, about 7.2 g of boron per square meter and per percent of nitrogen in the product, if the deposition is carried out with B₄C.

As may be clearly seen now, the present invention provides a solution for adapting, at a reduced cost, any presently used method to the manufacture of sintered nitrogenous ceramic products so that said products no longer have non-adherent particles on their surface. An anti-dust agent selected among calcium, boron or a mixture thereof simply needs to be incorporated or applied to the green part before sintering.

Of course, the present invention is not restricted to the exemplary and non-limiting embodiments described above.

Moreover, applying a coating composition to the surface of a green part is not the only way a ceramic product according to the present invention can be manufactured. For example, a film or layer of a powder of a material comprising calcium and/or boron could be deposited on at least one portion of the inner surface of the mold before pouring the starting charge. It is important that calcium and/or boron be present on the surface of the green part before sintering.

The coating composition is not necessarily in a liquid form, nor deposited in the form of a continuous layer. For example, a powder containing calcium and/or boron could be projected onto the surface of the green part.

1-14. (canceled)

15. A sintered ceramic product comprising a granular material bound by a nitrogenous matrix, wherein at least one anti-dust agent selected among calcium and boron is present in a surface layer of the product, and wherein the mass ratio of said anti-dust agents as a whole in said surface layer is greater than that measured underneath said layer.

16. The sintered ceramic product according to claim 15, wherein the granular material and the matrix are made of refractory materials.

17. The sintered ceramic product according to claim 15, wherein the surface layer has a mass ratio of anti-dust agents of 0.25% or more.

18. The sintered ceramic product according to claim 15, wherein the surface layer has a calcium or boron ratio greater than the ratio of calcium or boron, respectively, beneath said surface layer.

19. The sintered ceramic product according to claim 15, wherein the calcium and/or boron exists in the form of at least one calcium compound and/or at least one boron compound, respectively.

20. The sintered ceramic product according to claim 19, wherein the calcium compound and/or the boron compound is a non-oxide compound.

21. The sintered ceramic product according to claim 19, wherein the calcium compound is selected from the group consisting of oxides, carbides, nitrides, fluorides, metal alloys and calcium-containing organometallic compounds and the boron compound is selected from the group consisting of oxides, carbides, nitrides, fluorides, metal alloys, boron-containing organometallic compounds.

22. The sintered ceramic product according to claim 19, wherein the calcium compound is selected among CaB₆, CaSiO₃ and CaCO₃, and the boron compound is selected from B₄C, CaB₆, BN, TiB₂, and H₃BO₃.

23. The sintered ceramic product according to claim 15, wherein the surface layer has a thickness of less than 500 μm.

24. The sintered ceramic product according to claim 15, wherein, in the surface layer, the boron ratio is greater than 0.05% and/or the calcium ratio is greater than 0.2%, and, underneath said layer, the boron ratio is less than 0.05% and/or the calcium ratio is less than 0.2%, respectively, in percentages by weight.

25. The sintered ceramic product according to claim 15, wherein the granular material comprises grains of silicon nitride and/or SiAlON, and/or silicon carbide, and/or alumina.

26. A method for manufacturing a sintered ceramic product having a nitrogenous matrix, comprising a deposition of boron and/or calcium on at least one portion of the surface of a green part, and then a reactive sintering so as to manufacture a product according to claim 15.

27. The method for manufacturing a sintered ceramic product having a nitrogenous matrix according to claim 26, comprising the steps of:
a) preparing a green part;
b) depositing on at least one portion of the surface of the prepared green part a coating composition comprising boron and/or calcium;
c) before or after step b), drying said green part,
d) firing the coated and dried green part in a reducing nitrogen atmosphere or, possibly, if the green part comprises nitrogen, in any non-oxidizing atmosphere, at a temperature ranging between 1300 and 1600° C. so as to obtain a sintered product having a nitrogenous matrix.

28. A manufacturing method according to claim 26, wherein at least 0.1 g of dry material per square meter of coated surface and at most 70 g of dry material per square meter of coated material are deposited.

29. A manufacturing method according to claim 26, wherein the following amounts of boron and/or calcium are deposited on the green part:
in the absence of boron, at least 1.6 g, preferably, at least 3.2 g, of calcium (Ca) per square meter of surface and per percent of nitrogen in the composition of the final sintered product;
in the absence of calcium, at least 1.2 g, preferably at least 2.4 g, of boron (B) per square meter of surface and per percent of nitrogen in the composition of the final sintered product;
in the presence of boron and calcium, at least 0.4 g of calcium (Ca) and/or at least 0.6 g of boron (B) per square meter of coated surface and per percent of nitrogen in the composition of the final sintered product.

30. A manufacturing method according to claim 29, wherein the following amounts of boron and/or calcium are deposited on the green part:
in the presence of boron and calcium, at least 0.8 g of calcium (Ca) and/or at least 1.2 g of boron (B) per square meter of coated surface and per percent of nitrogen in the composition of the final sintered product.
